(19) United States
(12) Patent Application Publication
(10) Pub. No.: US 2011/0194751 A1
(43) Pub. Date: Aug. 11, 2011

(54) PATTERN VERIFICATION METHOD, PATTERN GENERATING METHOD, DEVICE FABRICATION METHOD, PATTERN VERIFICATION PROGRAM, AND PATTERN VERIFICATION SYSTEM

(76) Inventors: Michiya TAKIMOTO, Kanagawa-ken (JP); Takeshi Koshiba, Mie-ken (JP)

(21) Appl. No.: 13/023,332

(22) Filed: Feb. 8, 2011

(30) Foreign Application Priority Data
Feb. 10, 2010 (JP) P2010-27745

(51) Int. Cl. G06K 9/00

(52) U.S. Cl. 382/144

(57) ABSTRACT

A pattern verification method and the like for forming a desired pattern by using the imprint method are provided. A pattern verification method for a pattern forming method in which a template pattern of a template is transferred to a resist on a substrate to thus form a resist pattern, and the substrate is processed by using the resist pattern as a mask to thus form a processed pattern, the pattern verification method comprises: extracting any one of a design pattern of the processed pattern, a target pattern of the resist pattern, and a target pattern of the template pattern, as a verification pattern; and verifying whether the verification pattern is a critical pattern or not by comparing a feature value of the verification pattern with a feature value of a critical pattern.

### CROSS-REFERENCE TO RELATED APPLICATION

This application claims the benefit of priority from Japanese Patent Application No. 2010-27745, filed on Feb. 10, 2010, the entire contents of which are incorporated herein by reference.

### BACKGROUND OF THE INVENTION

1. Field of the Invention

The present invention relates to a pattern verification method and the like.

2. Description of the Related Art

In recent years, the imprint method for transferring an original pattern formed on the template onto a substrate is attracting an attention in manufacturing devices such as a semiconductor device, HDD, and a photodiode array. The imprint method is a method for forming a substrate pattern in the following manner. Specifically, an original mold (template) having a pattern formed therein is pressed onto a curable organic layer (resist) applied onto a substrate until the resist is filled into the pattern in the template. After the resist is cured, the template is detached from the resist (see U.S. Pat. No. 6,334,960).

With this imprint method, however, a desired pattern can not be formed on the substrate in some cases where the resist filled into the pattern is not sufficient and where the cured resist is peeled off from the substrate and closely attached to the template while the template is detached from the resist.

### BRIEF SUMMARY OF THE INVENTION

A pattern verification method according to an aspect of the present invention is a pattern verification method for a pattern forming method in which a template pattern of a template is transferred to a resist on a substrate to thus form a resist pattern, and the substrate is processed by using the resist pattern as a mask to thus form a processed pattern, the pattern verification method comprising; extracting any one of a design pattern of the processed pattern, a target pattern of the resist pattern, and a target pattern of the template pattern, as a verification pattern; and verifying whether the verification pattern is a critical pattern or not by comparing a feature value of the verification pattern with a feature value of a critical pattern.

A pattern generating method according to an aspect of the present invention is a pattern generating method for a pattern forming method in which a template pattern of a template is transferred to a resist on a substrate to thus form a resist pattern, and the substrate is processed by using the resist pattern as a mask to thus form a processed pattern, the pattern generating method comprising; extracting any one of a design pattern of the processed pattern, a target pattern of the resist pattern, and a target pattern of the template pattern, as a verification pattern; verifying whether the verification pattern is a critical pattern or not by comparing a feature value of the verification pattern with a feature value of a critical pattern; and adopting the verification pattern if the verification pattern is determined not to be a critical pattern as a result of the verification, and correcting the verification pattern in such a manner that the verification pattern does not become a critical pattern and adopting the corrected verification pattern if the verification pattern is determined to be a critical pattern.

A device fabrication method according to an aspect of the present invention is a device fabrication method on the basis of the verification pattern adopted in the pattern generating method for a pattern forming method in which a template pattern of a template is transferred to a resist on a substrate to thus form a resist pattern, and the substrate is processed by using the resist pattern as a mask to thus form a processed pattern, the pattern generating method comprising the steps of: extracting any one of a design pattern of the processed pattern, a target pattern of the resist pattern, and a target pattern of the template pattern, as a verification pattern; verifying whether the verification pattern is a critical pattern or not by comparing a feature value of the verification pattern with a feature value of a critical pattern; and adopting the verification pattern if the verification pattern is determined not to be a critical pattern as a result of the verification, and correcting the verification pattern in such a manner that the verification pattern does not become a critical pattern and adopting the corrected verification pattern if the verification pattern is determined to be a critical pattern.

A pattern verification program according to an aspect of the present invention is a pattern verification program for a pattern verification for a pattern forming method in which a template pattern of a template is transferred to a resist on a substrate to thus form a resist pattern, and the substrate is processed by using the resist pattern as a mask to thus form a processed pattern, the pattern verification program causing a computer to execute a procedure comprising; verifying whether a verification pattern is a critical pattern or not by comparing a feature value of the verification pattern with a feature value of the critical pattern, the feature value of the verification pattern including any one of a feature value of a design pattern of the processed pattern, a feature value of a target pattern of the resist pattern, and a feature value of a target pattern of the template pattern.

A pattern verification system according to an aspect of the present invention is a pattern verification system for use in a pattern forming method in which a template pattern of a template is transferred to a resist on a substrate to thus form a resist pattern, and the substrate is processed by using the resist pattern as a mask to thus form a processed pattern, wherein whether a verification pattern is a critical pattern or not is verified by comparing a feature value of the verification pattern with a feature value of the critical pattern, the feature value of the verification pattern including any one of a feature value of a design pattern of the processed pattern, a feature value of a target pattern of the resist pattern, and a feature value of a target pattern of the template pattern.

### BRIEF DESCRIPTION OF THE DRAWINGS

FIG. 1A to 1F are cross-sectional views illustrating processes in a method for manufacturing a template according to a first embodiment of the present invention.

FIG. 2A to 2E are cross-sectional views illustrating processes in a device fabrication method by using an imprint method according to the first embodiment of the present invention.

FIG. 3 is a flowchart illustrating a pattern generating method according to the first embodiment of the present invention.

FIG. 4 is a flowchart illustrating a pattern verification method according to the first embodiment of the present invention.

FIG. 5 is a flowchart illustrating a method for extracting feature values of a critical pattern according to the first embodiment of the present invention.

FIGS. 6A and 6B are diagrams illustrating a method for extracting the feature values of the critical pattern according to the first embodiment of the present invention.

FIG. 7 is a flowchart illustrating a pattern verification method according to a second embodiment of the present invention.

FIG. 8 is a flowchart illustrating a method for extracting feature values of a critical pattern according to the second embodiment of the present invention.

FIG. 9 is a flowchart illustrating a pattern verification method according to a third embodiment of the present invention.

FIG. 10 is a flowchart illustrating a method for extracting feature values of a critical pattern according to the third embodiment of the present invention.

FIG. 11 is a schematic diagram illustrating a configuration of a pattern verification system according to a fourth embodiment of the present invention.

### DETAILED DESCRIPTION OF THE INVENTION

Hereinafter, embodiments and the like of the present invention are described in detail with reference to the accompanying drawings.

### First Embodiment

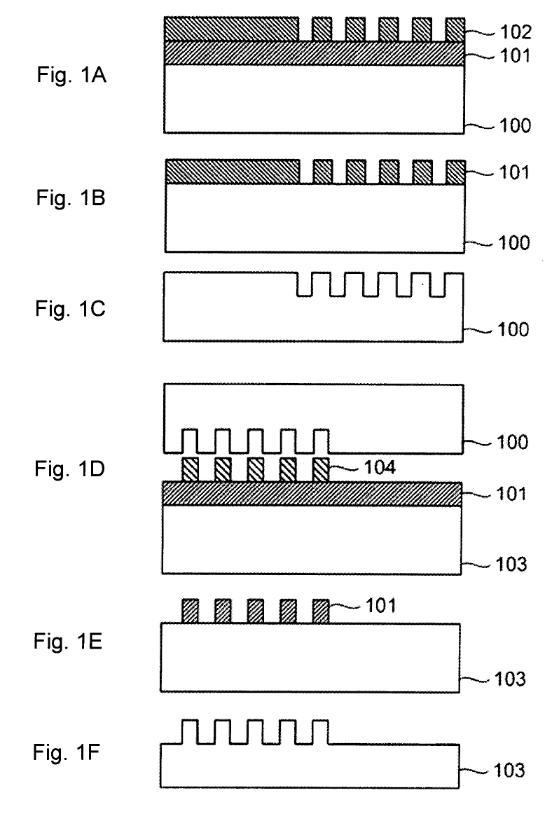

A method for manufacturing a template according to a first embodiment is described with reference to FIG. 1. FIG. 1A to 1F are cross-sectional views illustrating processes in a method for manufacturing a template according to the embodiment.

Firstly, a drawing pattern (data) to be formed on a template substrate is prepared. The drawing pattern is produced in such a manner that a design pattern of a circuit pattern to be formed on a device substrate such as a wafer is subjected to predetermined correction processing such as process proximity correction, and a dummy pattern is added to the design pattern.

Next, a template substrate 100 is prepared as shown in FIG. 1A. The template substrate 100 is a quartz substrate. A hard mask 101 (a film to be processed) and an resist 102 for drawing an EB pattern are sequentially formed as upper layers on the template substrate 100. The template substrate 100 is a substrate of a master template which serves as a master of templates (replica templates) which are to be used in the mass production for forming patterns on wafers by using the imprint method. It should be noted, however that, the pattern may be formed on the wafer also by the imprint method using the master template.

Then, a pattern is drawn on the resist 102 on the basis of the drawing pattern data by using a drawing apparatus. After drawing the pattern on the resist 102 by energy irradiation, a developer is fed to the resist 102 to thus form a resist pattern.

Next, while the resist 102 is used as a mask, the hard mask (HM) 101 underlying the resist 102 is etched. Thus, a hard mask pattern (HM pattern) 101 is formed as shown in FIG. 1B. After forming the hard mask pattern 101, the resist pattern 102 is removed.

Then, while the hard mask pattern 101 is used as a mask, the template substrate 100 underlying the hard mask pattern 101 is etched. Thus, a pattern is formed in the master template substrate 100 as shown in FIG. 1C. After forming a pattern in the master template substrate 100, the hard mask pattern 101 is removed.

A master template having a pattern can be manufactured through the above steps. Then, a method for manufacturing a template (a replica template) utilized in the mass production of semiconductor devices by using the imprint method is described below.

A replica template substrate 103 is prepared as shown in FIG. 1D. The replica template substrate 103 is a quartz substrate. A hard mask (a film to be processed) 101 and an imprint resist 104 are formed sequentially as upper layers on top of the replica template substrate 103. Further, the pattern of the master template 100 is transferred onto the imprint resist 104 by using the imprint process to thus form a resist pattern 104.

The imprint process is a commonly used imprint process. That is, this is a process for forming the resist pattern 104, the process including: bringing a pattern surface of the master template 100 into contact with the resist (curable organic material layer) 104 which is applied onto the replica template substrate 103; filling the resist 104 into the pattern of the master template 100; subjecting the resist 104 filled in the pattern to light irradiation or the like to thus cure the resist 104; detaching the master template 101 from the resist 104; and etching away the residual resist film 104 thinly remaining entirely over the substrate 103.

Next, while the resist pattern 104 formed by the imprint method is used as a mask, the hard mask (HM) 101 underlying the resist pattern 104 is etched. Thus, a hard mask pattern (HM pattern) 101 is formed as shown in FIG. 1E. After forming the hard mask pattern 101, the resist pattern 104 is removed.

Then, while the hard mask pattern 101 is used as a mask, the replica template substrate 103 underlying the hard mask pattern 101 is etched. Thus, a pattern is formed in the replica template substrate 103 as shown in FIG. 1F. After forming a pattern in the replica template substrate 103, the hard mask pattern 101 is removed.

A template used in manufacturing devices by using the template method can be formed through the above steps.

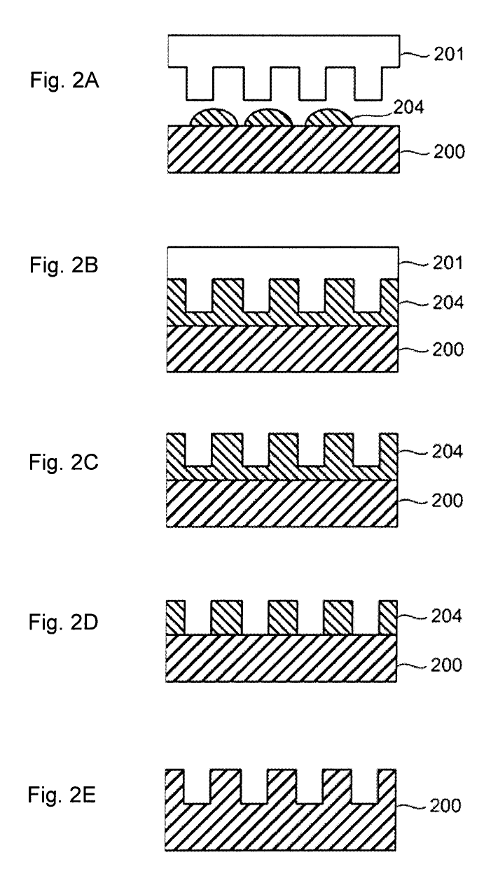

Subsequently, a device fabrication method by using an imprint method according to the embodiment is described with reference to FIG. 2A to 2E. FIG. 2A to 2E are cross-sectional views illustrating processes in a device fabrication method by using an imprint method according to the embodiment.

Firstly, as shown in FIG. 2A, an imprint resist 204 is applied onto a substrate to be processed (a device substrate) 200, for example, a semiconductor wafer. A film to be processed or a hard mask may be formed on the substrate 200 on which the imprint resist 204 is applied.

Then, as shown in FIG. 2B, a prepared template 201 is brought into contact with the resist 204 on the substrate 200, so that the resist 204 is filled into recessed portions in the pattern of the template 201. A replica template in which a pattern is formed in the step shown in FIG. 1F is used as the template 201. However, a master template in which a pattern is formed in the step shown in FIG. 1C may be used alternatively.

Then, after curing the resist 204 by light irradiation or the like, the template 201 is detached from the resist 204. Thus, the resist pattern 204 is formed as shown in FIG. 2C.

Then, the residual resist film 204 thinly remaining at the lower portion of the resist pattern 204 on the substrate 200 is removed by etching back. Thus, the resist pattern 204 can be formed on the substrate 200 as shown in FIG. 2D.

Further, while the resist pattern 204 is used as a mask, the substrate 200 is etched. Thus, a processed pattern can be formed in the substrate 200 as shown in FIG. 2E. The processed pattern, which is formed in the substrate 200 is, for example, a gate pattern of the semiconductor device, or the like.

A device such as a semiconductor device can be fabricated through the above steps by the imprint method using a template.

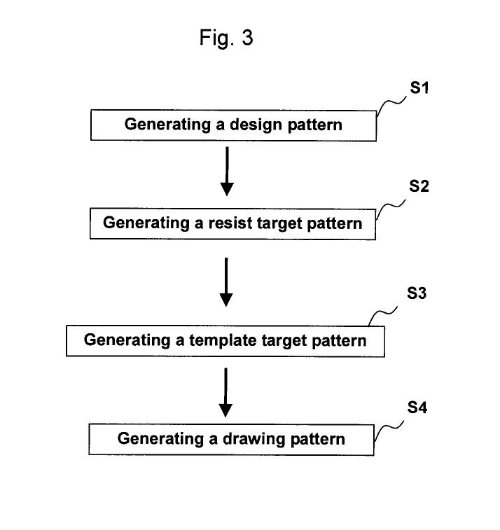

Subsequently, a flow of a pattern generating method according to the embodiment is described with reference to FIG. 3. FIG. 3 is a flowchart illustrating a method for forming various patterns according to the embodiment.

Firstly, a design pattern of a processed pattern to be formed on a device substrate is generated in Step 1 (S1) as shown in FIG. 3. The design pattern is GDS data, for example, or the like, which is produced by a design tool. Here, the design pattern is the design pattern of the processed pattern formed in the substrate shown in FIG. 2. For example, the design pattern is one for a line and space shaped gate pattern of a semiconductor.

Then, a resist target pattern is generated on the basis of the design pattern as shown in Step 2 (S2) of FIG. 3. The resist target pattern is a pattern which should be formed on the resist on the substrate, and is a target value of the resist pattern as shown in FIG. 2D.

As shown in FIG. 2D and FIG. 2E, in the imprint method, a pattern is formed on a substrate by etching the substrate while the resist pattern is used as a mask. At that time, patterns obtained after etching vary depending on conditions including feature values of the resist pattern (pattern-to-pattern distance, pattern density, pattern shape, pattern circumference length, pattern dimensions, and pattern depth), etching conditions (etching time and gas types), and a material for a substrate serving as a process target film (insulation film, metal film, polysilicon film, or the like). In short, differences in pattern dimensions, pattern shape, and the like arise between the resist pattern and the processed pattern which is occurred on the substrate by etching.

In the resist target pattern formation process, pattern variations caused by etching are considered. Thus, the resist target pattern is generated by correcting the proximity effect attributable to the etching process. The correction may be performed by either rule base correction or simulation base correction.

In the rule base correction, a rule of the pattern variation before and after etching is predetermined by repeating experiments and simulation of the imprint method in advance, and a resist target pattern is determined by correcting the design pattern with reference to the rule. The rule specifies the relationship between feature values of the resist pattern (pattern-to-pattern distance, pattern density, pattern shape, pattern dimensions, pattern depth, and the like) and the amount of pattern variations caused by etching (difference between the resist pattern and the processed pattern). To be more specific, if it is found that a periodic line and space pattern having the same width formed on a substrate has a line width of 18 nm when being etched while a resist pattern which is spaced by 40 nm from an adjacent pattern (pattern-to-pattern distance) is used as a mask, it is specified as a rule that the pattern reduces its line width by 2 nm by etching in which a resist pattern having a pattern-to-pattern distance of 40 nm is used as a mask. With reference to this rule, a resist target pattern can be produced in such a manner as to increase its line width by 2 nm on the basis of a design pattern having the pattern-to-pattern distance of 40 nm. If similar rules related to design patterns having different pattern-to-pattern distances are determined, resist target patterns can be generated from the design patterns in accordance with the rules.

On the other hand, in the simulation base correction, the amount of pattern variation is determined through etching simulation for each design pattern to be corrected, and a resist pattern target is generated considering the determined amount of pattern variation. For example, if it is determined through the etching simulation that the pattern reduces its size by 2 nm when being etched while a resist pattern is used as a mask, the resist target pattern is produced to be larger by 2 nm than a predetermined design pattern is generated in order to form a processed pattern by etching in such a manner that the processed pattern matches the design pattern.

A resist target pattern may be also formed by adding a dummy pattern to the design pattern so as to suppress pattern variations caused by etching. It is preferable that the dummy pattern is formed electrically independent from a device pattern (for example, a circuit pattern) and that it does not affect electrical properties of the device. In the etching process, dimensions and a shape of the etched pattern on the substrate vary in some cases depending on the density of the resist pattern serving as a mask. For this reason, the resist target pattern is generated by adding a dummy pattern to the design pattern in order that the density of the resist target pattern becomes constant within a predetermined range. For example, a resist target pattern is generated by adding, to a design pattern including lines and spaces generated in predetermined cycles, one or more line-shaped dummy patterns. In this respect, the one or more line-shaped dummy patterns are added in such a manner as to maintain the predetermined cycles outside a farthest line portion of the lines and spaces. In this manner, the design pattern has closer pattern densities at the farthest portion of the lines and spaces and at the central portions. This enables making constant dimensions, shapes, and cycles of the lines and space pattern to be formed on the substrate by etching.

Then, a template target pattern is generated on the basis of the resist target pattern as shown in Step 3 (S3) of FIG. 3. The template target pattern is a pattern which should be formed on a template substrate used in the imprint method, and is a target value of the pattern formed on the template shown in FIG. 2A.

In the imprint method, the resist pattern is formed by transferring a template pattern to the resist as shown in FIGS. 2A to 2C or FIG. 2D.

In the event of transfer, the property of the resist filled into the template pattern as shown in FIG. 2B is affected in some cases depending on feature values of the template pattern (pattern-to-pattern distance, pattern density, pattern circumference length, pattern shape, pattern dimensions, or pattern depth), the amount of resist, and distribution of the resist in FIG. 2A. For example, if the amount of the resist is small, the amount of resist filled into the template pattern is insufficient, which may result in reducing dimensions of the filled-in resist. The reduced dimension of the filled-in resist thus reduces the dimension of the resist pattern shown in FIG. 2C or 2D. As has been described, there is a pattern variation between a pattern formed on the template and the resist pattern, in some cases, depending on process conditions such as the amount of resist, distribution of the resist, or the like.

In the template target pattern generation step, pattern variations depending on feature values of the template pattern, the amount of resist, and distribution of the resist can be considered. That is, the rule base correction or the simulation base correction is performed depending on the amount of resist and distribution of the resist, and thus a template target pattern is determined from a resist target pattern.

For example, experiments or simulation of the imprint steps shown in FIGS. 2A to 2C or the step shown in FIG. 2D are performed in advance and thus a correlation between the pattern variations and process conditions, such as the amount of resist or distribution of the resist, is determined. In this respect, the pattern variations are variations which occur between a template pattern and a resist pattern. Then, a template target pattern can be produced in such a manner that a resist pattern formed by using the imprint method matches the resist target pattern with reference to the correlation. For example, if it is determined that a resist pattern formed on the substrate decreases its size by 3 nm than a template pattern when a predetermined amount of resist is applied in such a manner that the applied resist distributes to a predetermined extent, the template target pattern is generated in such a manner that the template target pattern becomes larger by 3 nm than the resist target pattern.

The property of the resist filled into the template pattern as shown in FIG. 2B is also affected by process conditions including contact pressure, contact rate, and contact angle of the template to the resist, template holding time from contact to the resist until start of curing the resist. These process conditions also cause pattern variations. Therefore, as in the case of the amount of resist and distribution of the resist, pattern variations depending process conditions including contact pressure, contact rate, and contact angle of the template to the resist, template holding time, and the like are considered in determining a template target pattern from a resist target pattern. Specifically, the template target pattern can be determined from the resist target pattern by performing the rule base correction or simulation base correction.

Further, pattern variations resulting from shrinkage of the resist in the resist curing step and detachment of the resist from the template in the step in FIG. 2C can be considered. Pattern variations resulting from cure shrinkage of the resist which should be considered can be obtained by associating the amount of pattern variations before and after curing with process conditions including resist material, wavelength of light used for curing the resist, irradiation time of the light, resist curing rate, and the like. Pattern variations resulting from detachment of the template which should be considered can be obtained by associating the amount of pattern variations with process conditions including detachment rate, detachment angle, detachment stress, and the like. If these associations between the amounts of the pattern variations with these process conditions are required when rule base correction or simulation correction is performed, a template target pattern can be determined from a resist target pattern considering the amount of the pattern variations.

Also, the amount of pattern variation of the resist before and after etching back, resulting from etching back a residual resist film as shown in FIG. 2D can be considered. The amount of pattern variations resulting from etch backing the residual resist film which should be considered can be obtained by associating the amount of pattern variations resulting from etching-back with process conditions including feature values of a resist pattern before being etched (pattern-to-pattern distance, pattern density, pattern shape, pattern size, or pattern depth), resist materials, etching conditions (etching gas types, etching time, and the like), and the like.

By integrating the amounts of the pattern variations based on the afore-mentioned pattern variation factors, the amount of pattern variations can be obtained, on which basis a template target pattern can be determined from a resist target pattern.

Further, a template target pattern can be generated by adding a dummy pattern to the resist target pattern. For example, a dummy pattern can be generated in such a manner that the resist target pattern has the pattern density which is as constant as possible across the template surface, by uniformizing, across the template surface, the property of the resist filled into the template pattern and stress applied to the template in detaching the template from the resist. The dummy pattern is generated for the purposes of causing the template surface to have the constant amount of pattern variations and uniformizing the amount of pattern variations within the template when the residual resist film is etched back.

Then, a drawing pattern is generated from the template target pattern as shown in Step 4 (S4) of FIG. 3. The drawing pattern is entered into a drawing apparatus, and a pattern is drawn on the template substrate by operating the drawing apparatus on the basis of the entered drawing pattern as shown in FIG. 1A.

The template pattern is formed on the template substrate in the template manufacturing step shown in FIG. 1 on the basis of the drawing pattern in such a manner that the difference between the finally formed template pattern and the template target pattern falls within an allowable range. For this reason, before determining a drawing pattern from a template target pattern, the amount of pattern variations caused in various processes in the template manufacture must be determined and the drawing pattern must be determined considering the determined amount of the pattern variations. Here, the finally formed template pattern represents a pattern formed on a replica template (a template shown in FIG. 1F) used for device fabrication, but when manufacturing a device using a master template (a template shown in FIG. 1C), template pattern represents a pattern formed on a master template.

When a replica template is used in device fabrication, a drawing pattern is determined by correcting a template target pattern in consideration of the amount of pattern variations attributable to the processes shown in FIG. 1A to FIG. 1F (drawing process, resist development process, etching process, and imprint process). When a master template is used in device fabrication, a drawing pattern is determined by correcting a template target pattern in consideration of the amount of pattern variations attributable to processes shown in FIG. A to FIG. 1C (drawing process, resist development process, and etching process). As a correction method, such rule base correction method or simulation base correction method as described above can be used.

After producing the drawing pattern as described above, a template can be fabricated on the basis of the drawing pattern. Further, a pattern can be formed on a device substrate by performing the imprint method using the fabricated template, and thus a device can be fabricated. The method of manufacturing the template and device is the same as described above with reference to FIG. 1 and FIG. 2.

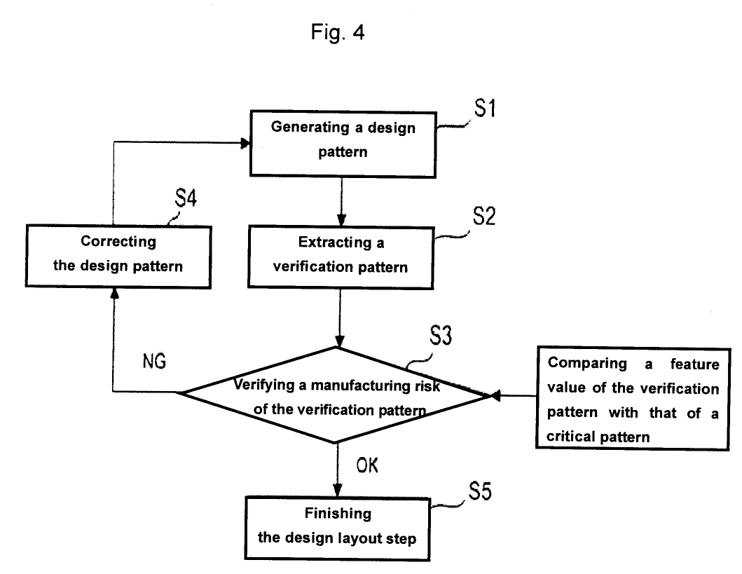

Subsequently, a pattern verification method according to the embodiment is described with reference to FIG. 4. FIG. 4 is a flowchart illustrating the pattern verification method according to the embodiment.

First, a design pattern is produced as shown in Step 1 (S1) of FIG. 4. The design pattern is a design pattern of a processed pattern, to be formed on a device substrate using the imprint method.

Then, a verification pattern to be verified is extracted out of design patterns as shown in Step 2 (S2) of FIG. 4. The verification pattern is a pattern which satisfies predetermined conditions out of design patterns. Here, the predetermined conditions may be set appropriately. Examples of the predetermined conditions include to arrange the design pattern within a predetermined range and to make the pattern-to-pattern gap or the pattern width smaller than a predetermined value.

Next, risk of an extracted verification pattern is verified as shown in Step 3 (S3) of FIG. 4. In the manufacturing risk verification, a verification pattern can be determined as a critical pattern in a case where a pattern formed on a device substrate by using the imprint method on the basis of the design pattern extracted as the verification pattern does not satisfy desired conditions, or in a case where properties of a device having the substrate pattern do not satisfy the desired conditions. Further, in a case where process margins in the process forming the verification pattern on the substrate do not satisfy desired margins, the verification pattern can be determined as a critical pattern.

Cases where patterns on substrates do not satisfy desired conditions include, for example, a case where the substrate pattern exhibits an open failure or short failure and a case where at least one of dimensions, density, gap, and shape of the substrate pattern does not satisfy desired conditions. A case where device properties do not satisfy desired conditions represents a case where a signal delay and the like occur during device operation.

The risk verification step of the verification pattern does not involve actually forming a substrate pattern on the basis of the verification pattern or predicting a pattern to be formed on the substrate by simulation, in order to determine whether or not a pattern formed on the substrate on the basis of the verification pattern satisfies desired conditions or whether or not functions of a device having the substrate pattern satisfies desired conditions. Instead, risk of a verification pattern is verified in the risk verification step by determining whether or not the verification pattern has pattern feature values which are equivalent to those of a critical pattern. In this respect, the feature value represents an evaluation index containing any one of the pattern's shape, dimensions (length, width, diameter, and the like), density, circumference length, and gap from an adjacent pattern, and depth of the template. When having predetermined pattern feature values, the verification pattern is determined as a critical pattern. The predetermined pattern feature value refers to a feature value leading to a critical pattern (feature value of critical pattern).

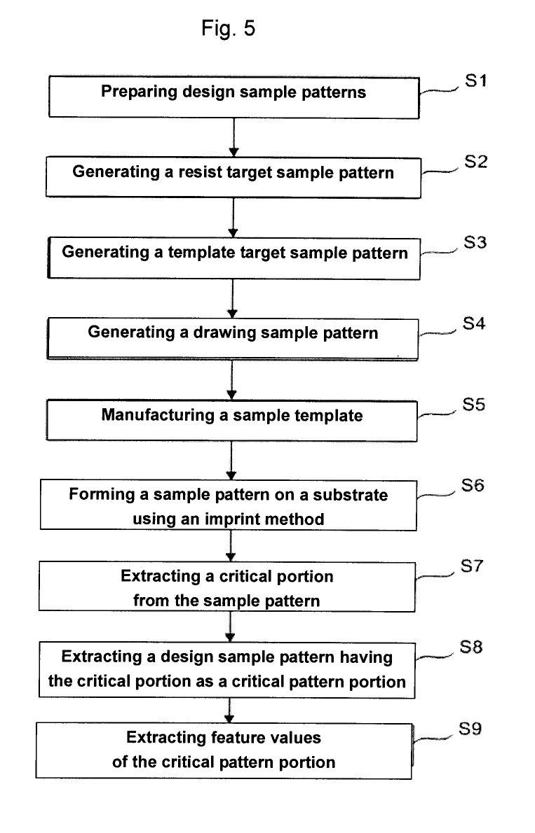

As described above, the risk is verified only on the basis of whether or not a verification pattern has a feature value of the critical pattern, by omitting formation of a pattern on the substrate. Thus, whether the verification pattern is good or not can be verified promptly. In this respect, the feature value leading to a critical pattern is determined in advance before performing the verification. The method for determining the feature value leading to a critical pattern is described later with reference to FIG. 5.

If a verification result indicating that the verification pattern is a critical pattern is obtained as a result of the verification, a design pattern representing the verification pattern is corrected as shown in Step 4 (S4) of FIG. 4. Then, steps comprising producing a design pattern again by using the corrected design pattern (S1), extracting the corrected design pattern as a verification pattern (S2), and verifying the verification pattern (S3) are repeated. The correction and verification is repeated until the verification pattern is determined not to be a critical pattern in the verification pattern verification step (S3).

Any method may be used as a method for correcting the verification pattern. However, a pattern correction can be performed, for example, in such a manner that the line width of the verification pattern is increased, if a pattern formed on the substrate can be determined as having an open failure on the basis of the comparison between the feature values of the pattern and those of a critical pattern in S3. On the other hand, a pattern correction can be performed, for example, in such a manner that the line width of the verification pattern is decreased, if a pattern formed on the substrate can be determined as having a short failure on the basis of the comparison. Further, if it can be determined that the process margin becomes low, a pattern correction can be performed in such a manner that a gap from an adjacent pattern is increased.

As shown in Step 5 (S5) of FIG. 4, if the verification pattern is determined not to be a critical pattern as a result of the risk verification of the verification pattern, the verification pattern is adopted as a design pattern for device fabrication. Thereafter, a device can be fabricated on the basis of the design pattern. For example, a semiconductor device can be fabricated by forming a circuit pattern corresponding to the design pattern on a semiconductor substrate. As a fabrication method, a template fabrication method and a device fabrication method described with reference to FIG. 1 and FIG. 2 may be used.

Then, a method for acquiring the feature value of the critical pattern referred to in the verification pattern verification step shown in Step 3 of FIG. 4 is described with reference to FIG. 5.

First, design sample patterns being the test samples are prepared as shown in Step 1 (S1) of FIG. 5. A plurality of patterns having different pattern feature values are prepared as the design sample patterns.

Then, a resist target sample pattern is generated on the basis of the design sample patterns as shown in Step 2 (S2) of FIG. 5. The resist target sample pattern is produced by using a method similar to the method for producing the resist target pattern described in Step 2 (S2) in FIG. 3. That is, the resist target sample pattern is produced by considering the amount of pattern variations between a resist pattern and a pattern obtained by etching by using the resist pattern as a mask.

Then, a template target sample pattern is generated on the basis of the resist target sample pattern as shown in Step 3 (S3) of FIG. 5. The template target sample pattern is produced by using a method similar to the method for producing the template target pattern described in Step 3 (S3) in FIG. 3. That is, the template target sample pattern is produced from the resist target sample pattern by considering the amount of pattern variations between a template pattern and a resist pattern formed on the substrate by the imprint method by using a template on which the template pattern is formed.

Then, a drawing sample pattern is generated on the basis of the template target sample pattern as shown in Step 4 (S4) of FIG. 5. The drawing sample pattern is produced by using a method similar to the method for producing the drawing pattern described in Step 4 (S4) of FIG. 3. That is, the drawing sample pattern is produced by considering the amount of pattern variations between the drawing pattern and the template pattern formed on the template on the basis of the drawing pattern.

Then, a sample template is manufactured on the basis of the drawing sample pattern as shown in Step 5 (S5) of FIG. 5. The sample template is manufactured on the basis of the drawing sample pattern by using a method similar to the method for manufacturing the master template or replica template described with reference to FIG. 1.

Then, a sample pattern is formed on a device substrate by the imprint method using the sample template as shown in Step 6 (S6) of FIG. 5. The sample pattern is formed on the substrate by the imprint method, in the similar manner to the method for forming the pattern on the substrate described with reference to FIG. 2.

Although the example of actually performing the fabrication processes is described in the sample template fabrication step and the substrate sample pattern forming step shown in S5 and S6 of FIG. 5, the sample template and a substrate sample pattern may be predicted and determined by simulating those processes.

Next, a critical portion is extracted from the sample pattern on the substrate determined by the experiment or simulation as shown in Step 7 (S7) of FIG. 5. The critical portion refers to a portion having an open failure or short failure, of the sample pattern on the substrate, and a portion where any one of size, density, gap, and shape does not satisfy desired requirements. Also, a portion of the sample pattern on the substrate causing device property failure can be classified as the critical portion. In this respect, the device property failure refers to a case where the properties of a device configured by the sample pattern on the substrate do not satisfy desired requirements. Further, a portion of the sample pattern where the process margin does not satisfy desired requirements can also be classified as a critical portion.

Next, a portion of the design sample pattern corresponding to the critical portion is extracted as a critical pattern portion as shown in Step 8 (S8) of FIG. 5. The portion of the design sample pattern corresponding to the critical portion represents a portion of the design sample pattern serving as an original used in forming the portion of the sample pattern on the substrate determined as a critical portion.

Finally, feature values of the critical pattern portion are extracted as shown in Step 9 (S9) of FIG. 5. That is, at least one feature value is extracted out of pattern shape, dimensions, density, and circumference length of the critical pattern portion, distance from the pattern profile, and gap from an adjacent pattern. Further, extracted feature values of the critical pattern portion may be stored in the form of a data base, table, or function. To store in the form of function means that to take a plurality of samples from feature values of a design pattern determined as having a critical pattern portion and to represent whether or not the portion is classified as a critical pattern portion by a specific function approximating the samples thus taken. When storing in the form of function, a function representing the risk may be created by using a plurality of feature value types. For example, a function representing the critical pattern portion may be created by using an index combining pattern's dimensions and a gap from an adjacent pattern, out of the feature values.

Preferably, properties of the critical pattern portion (that is, risk types such as short failure and open failure) and feature values are associated with each other and are stored in the form of data base.

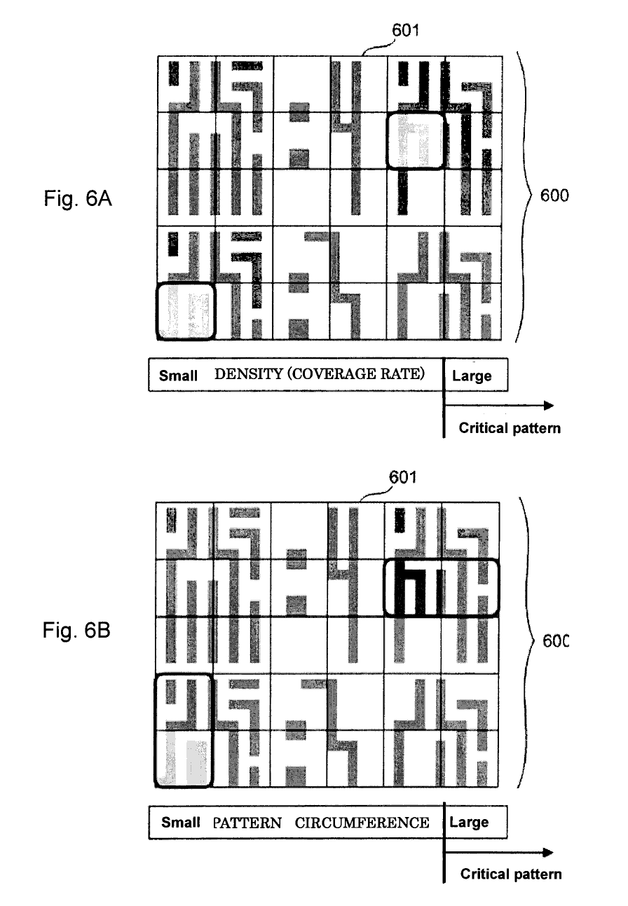

A method for extracting the feature values of a critical pattern portion of a design sample pattern is described with reference to FIGS. 6A and 6B. FIGS. 6A and 6B are diagrams illustrating the method for extracting the feature values of the critical pattern of the design sample pattern.

As shown in FIG. 6, a design sample pattern 600 is partitioned in the form of mesh, and the feature value is calculated for each of meshes 601. In FIG. 6A, the pattern density (coverage rate) in each mesh 601 is calculated as a feature value, while in FIG. 6B, the sum of the pattern circumference lengths in the mesh 601 is calculated as a feature value. Meanwhile, a critical pattern portion in the design sample pattern 600 is extracted to determine which mesh 601 contains a critical pattern portion. FIG. 6 indicates that a critical pattern portions exist in the meshes 601 enclosed with black line frames. Further, feature values of the critical pattern portion in the design sample pattern 600 can be determined by associating the critical pattern portion with the feature values of the mesh containing the critical pattern portion. In FIG. 6A, a design sample pattern area having a pattern density higher than a predetermined value is determined as a critical pattern portion, while in FIG. 6B, a design sample pattern area having a pattern circumference length longer than a predetermined value is determined as a critical pattern portion.

As described above, according to the pattern verification method according to the present invention, verification of a design pattern can be conducted on the basis of information as to which feature value of the design pattern causes a critical pattern. That is, when forming a pattern on a device substrate by using the imprint method, whether the design pattern is good or not can be verified easily and promptly by comparing the feature values of the design pattern and the feature values of a critical pattern.

Further, the feature values of the critical pattern are calculated by considering variations of a substrate pattern in processes for forming the pattern on a device substrate on the basis of the imprint method. Therefore, a desired pattern can be formed on the device substrate by manufacturing a device on the basis of a pattern verified by a pattern verification method according to the embodiment.

### Second Embodiment

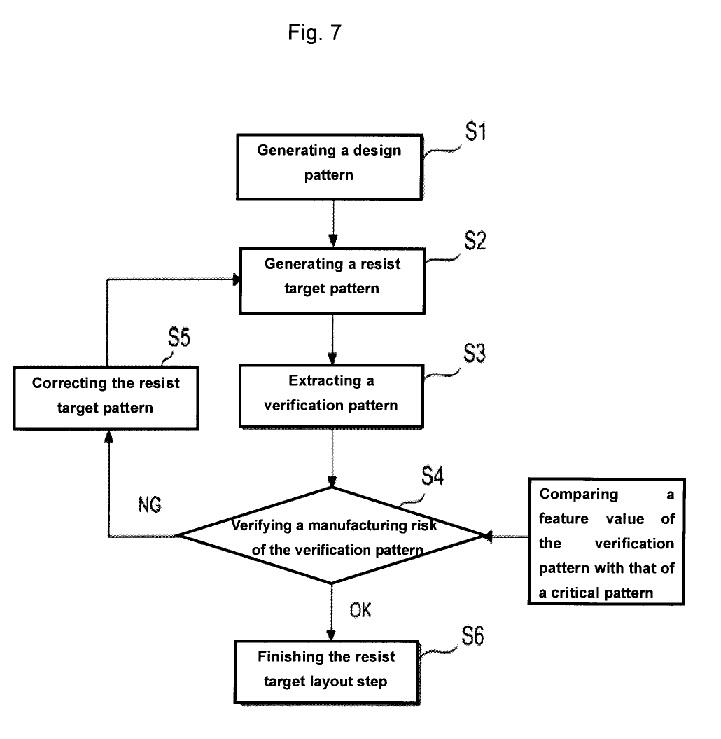

A pattern verification method according to a second embodiment is described with reference to FIG. 7. FIG. 7 is a flowchart illustrating the pattern verification method according to the embodiment. The pattern verification method according to the embodiment is different from the pattern verification method according to the first embodiment (see FIG. 4) in that a resist target pattern is generated, a verification pattern is extracted therefrom, and then corrected if necessary. However, but other process flows are almost same with each other. Therefore, detailed description thereof is omitted.

First, a design pattern for a processed pattern to be formed on a device substrate is produced as shown in Step 1 (S1) of FIG. 7.

Next, resist target patterns are generated on the basis of the design pattern as shown in Step 2 (S2) of FIG. 7. The resist target patterns are produced by using a method similar to the method described with reference to (S2) of FIG. 3. That is, the resist target patterns are produced considering the amount of pattern variations between a resist pattern and a pattern obtained by etching the pattern by using the resist pattern as a mask.

Next, a verification pattern is extracted from the resist target patterns as shown in Step 3 (S3) of FIG. 7. The verification pattern represents a pattern which satisfies predetermined requirements out of the resist target patterns. Here, predetermined requirements may be set appropriately, but for example, the predetermined requirements may include that a verification pattern has the pattern density and the circumference length which are smaller or larger than predetermined values.

Next, risk of the extracted verification pattern is verified as shown in Step 4 (S4) of FIG. 7. Similarly to the first embodiment, whether or not the verification pattern has feature values of a critical pattern prepared in advance is determined by comparing feature values of the critical pattern with feature values of the verification pattern. The determination is made to verify whether the verification pattern is a critical pattern or not. That is, when the verification pattern has the feature value equivalent to the feature value of the critical pattern, it is determined that the verification pattern is a critical pattern.

If verification result indicating that the verification pattern is a critical pattern is obtained as a result of the verification, the resist target pattern being the verification pattern is corrected as shown in Step 5 (S5) of FIG. 7. Then, the following steps are repeated: a resist target pattern is produced again using the corrected resist target pattern (S2); the corrected resist target pattern is extracted as a verification pattern (S3); and the verification pattern verification step (S4) is performed. The correction and verification are repeated until the verification pattern is determined not to be a critical pattern in the verification pattern verification step (S4). As a method for correcting the verification pattern, a method similar to the method for correcting a verification pattern described in the first embodiment may be used.

As shown in Step 6 (S6) of FIG. 7, when the verification pattern is determined not to be a critical pattern as a result of the risk verification of the verification pattern, the verification pattern is adopted as a resist target pattern for device fabrication. Thereafter, a device can be fabricated on the basis of the resist target pattern. For example, a semiconductor device can be fabricated by forming a resist pattern corresponding to the resist target pattern on a semiconductor substrate and etching the substrate by using the resist pattern as a mask.

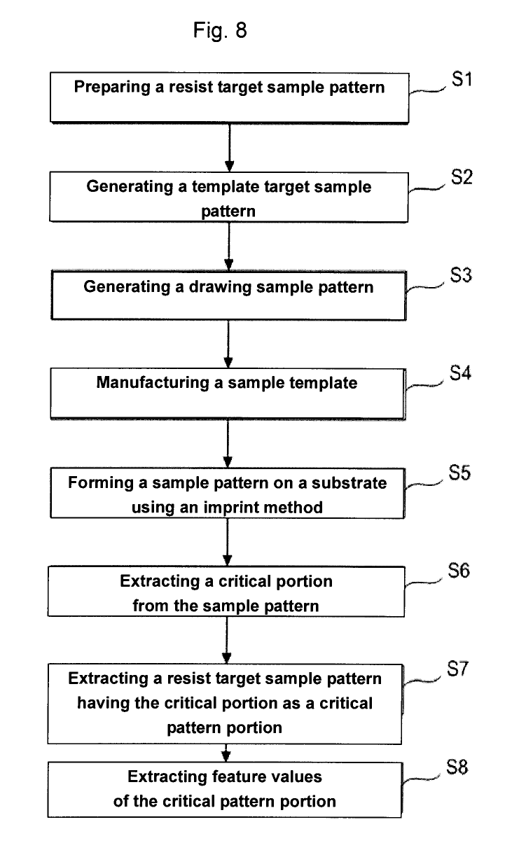

Next, a method for acquiring feature values of the critical pattern referred to in the verification pattern verification step shown in Step 4 (S4) of FIG. 7 is described with reference to FIG. 8. The method for extracting feature values of a critical pattern according to the embodiment is different from the method for extracting feature values of a critical pattern according to the first embodiment in that a critical pattern is extracted out of resist target patterns, but other processes are almost same. Therefore, detailed description thereof is omitted.

First, a resist target sample pattern is prepared as shown in Step 1 (S1) of FIG. 8. Then, a template target sample pattern is generated on the basis of the resist target sample as shown in Step 2 (S2) of FIG. 8. Then, a drawing sample pattern is generated from the template target sample pattern as shown in Step 3 (S3) of FIG. 8. Then, a sample template is manufactured on the basis of the drawing sample pattern as shown in Step 4 (S4) of FIG. 8. Then, a sample pattern is formed on a device substrate by the imprint method using the sample template as shown in Step 5 (S5) of FIG. 8.

Although examples of actually performing the fabrication processes are described with reference to the sample template manufacturing step and the step of forming a substrate sample pattern shown in S4 and S5 of FIG. 8, the sample template and a substrate sample pattern can be predicted and determined by simulating those processes.

Then, a critical portion is extracted from the sample pattern on the substrate acquired by experiments or simulation as shown in Step 6 (S6) of FIG. 8.

Then, a portion of the resist target sample pattern corresponding to the critical portion is extracted as a critical pattern portion as shown in Step 7 (S7) of FIG. 8. The portion of the resist target sample pattern corresponding to the critical portion denotes a target pattern portion of the resist pattern which serves as a mask in forming by etching a portion of the sample pattern on the substrate determined as a as a critical portion.

Finally, feature values of the critical pattern portion are extracted as shown in Step 8 (S8) of FIG. 8. Specifically, at least one feature value is extracted out of pattern shape, dimensions, density, and circumference length of the critical pattern portion, distance from the pattern profile, a gap from an adjacent pattern, and a pattern depth.

As described above, with the pattern verification method according to the embodiment, it is possible to verify the resist target pattern on the basis of a feature value which causes the resist target pattern to be determined as a critical pattern. That is, when forming a pattern on a device substrate using the imprint method, whether the resist target pattern is good or not can be easily and promptly verified by comparing the feature values of the resist target pattern and the feature values of a critical pattern.

Feature values of the critical pattern are calculated by considering variations of the patterns on the substrate in processes for forming the pattern on the device substrate on the basis of the imprint method. Therefore, a desired pattern can be formed on the device substrate by manufacturing the device on the basis of a pattern verified by the pattern verification method according to the embodiment.

Further, the pattern verification method according to the embodiment can reduce designer's correction workload more than the method according to the first embodiment does since only the resist target pattern is corrected without correcting the design pattern. However, when it is determined in the verification step shown in (S4) of FIG. 7 that a critical pattern is contained in the verification pattern, the design pattern also may be corrected so as to produce a further precise resist target pattern. In this case, a resist target pattern is generated again after correction of the design pattern, and steps (S1) through (S4) shown in FIG. 7 are repeated until it is determined that a critical pattern is not contained in the verification pattern.

### Third Embodiment

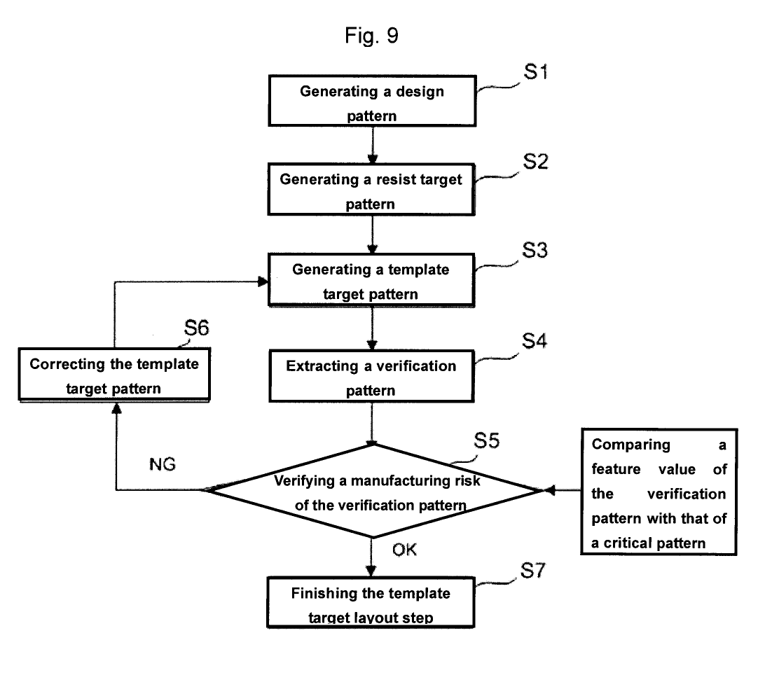

A pattern verification method according to a third embodiment is described with reference to FIG. 9. FIG. 9 is a flowchart illustrating the pattern verification method according to the embodiment. The pattern verification method according to the embodiment is different from the pattern verification method according to the first embodiment (see FIG. 4) in that a template target pattern is generated, a verification pattern is extracted as a verification pattern, and then corrected if necessary. However, but other process flows are almost same with each other. Therefore, detailed description thereof is omitted.

First, a design pattern for a pattern to be formed on a device substrate is generated as shown in Step 1 (S1) of FIG. 9.

Next, resist target patterns are generated on the basis of the design pattern as shown in Step 2 (S2) of FIG. 9. The resist target patterns are generated by using a method similar to the method described with reference to (S2) of FIG. 3. That is, the resist target patterns are generated considering the amount of pattern variations between a resist pattern and a pattern obtained by etching the pattern by using the resist pattern as a mask.

Then, a template target patterns are generated on the basis of the resist target pattern as shown in Step 3 (S3) of FIG. 9. The template target patterns are generated by a method similar to the method described with reference to (S3) of FIG. 3. That is, the template target patterns are generated considering the amount of pattern variations between the template pattern and a resist pattern formed on the substrate by the imprint method using the template on which the template pattern is formed.

Then, a verification pattern is extracted out of the template target patterns as shown in Step 4 (S4) of FIG. 9. Although the verification pattern can be extracted appropriately out of the template target patterns, the pattern which can be extracted is a pattern having a portion where load is likely to be applied when detaching the template from a resist in the imprint process, for example, a pattern having the pattern density or circumference length larger than a predetermined value, that is, a pattern whose contact area with the resist is larger than a predetermined value. A pattern defect is likely to occur at such portions that are highly affected by the resist when the template is detached therefrom.

Then, manufacturing risk of the extracted verification pattern is verified as shown in Step 5 (S5) of FIG. 9. Similarly to the first embodiment, verification is made by determining whether the verification pattern is a critical pattern or not.

If verification result indicating that the verification pattern is a critical pattern is obtained as a result of the verification, the template target pattern being the verification pattern is corrected as shown in Step 6 (S6) of FIG. 9. Then, the following steps are repeated: a template target pattern is produced again using the corrected template target pattern (S3); the corrected template target pattern is extracted as a verification pattern (S4); and the verification pattern verification step (S5) is performed. The correction and verification are repeated until the verification pattern is determined not to be a critical pattern in the verification pattern verification step (S5). As a method for correcting the verification pattern, a method similar to the method for correcting a verification pattern described in the first embodiment may be used.

As shown in Step 7 (S7) of FIG. 9, when the verification pattern is determined not to be a critical pattern as a result of the risk verification of the verification pattern, the verification pattern is adopted as a template target pattern to be formed on a template for device fabrication. Thereafter, a device, such as a semiconductor device, can be fabricated by manufacturing a template on the basis of the template target pattern and then by using the imprint method using the template.

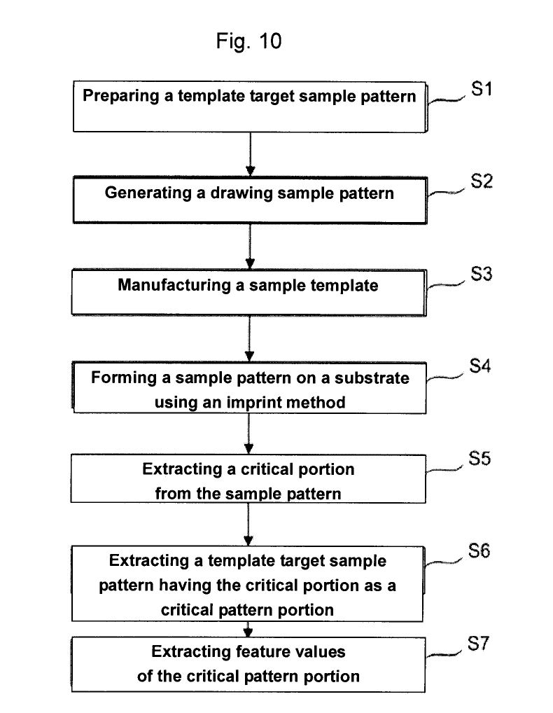

Next, a method for acquiring feature values of the critical pattern referred to in the verification pattern verification step shown in Step 5 (S5) of FIG. 9 is described with reference to FIG. 10. The method for extracting feature values of a critical pattern according to the embodiment is different from the method for extracting feature values of a critical pattern according to the first embodiment in that a critical pattern is extracted out of template target patterns, but other processes are almost same. Therefore, detailed description thereof is omitted.

First, a template target sample pattern is prepared as shown in Step 1 (S1) of FIG. 10. Then, a drawing sample pattern is generated from the template target sample pattern as shown in Step 2 (S2) of FIG. 10. Then, a sample template is manufactured based on the drawing sample pattern as shown in Step 3 (S3) of FIG. 10. Then, a sample pattern is formed on a device substrate by the imprint method using the sample template as shown in Step 4 (S4) of FIG. 10. Although examples of actually performing the fabrication processes are described with reference to the sample template fabrication step and the step of forming a substrate sample pattern shown in S3 and S4 of FIG. 10, the sample template and a substrate sample pattern can be predicted and determined by simulating those processes.

Then, a critical portion is extracted from the sample pattern on the substrate acquired by experiments or simulation as shown in Step 5 (S5) of FIG. 10.

Then, a portion of the template target sample pattern corresponding to the critical portion is extracted as a critical pattern portion as shown in Step 6 (S6) of FIG. 10. The portion of the template target sample pattern corresponding to the critical portion denotes a target pattern portion of the template pattern corresponding to the critical portion in forming a portion of the sample pattern on the substrate determined as a as a critical portion by the imprint method using a template.

Finally, feature values of the critical pattern portion are extracted as shown in Step 7 (S7) of FIG. 10. Specifically, at least one feature value is extracted out of pattern shape, dimensions, density, and circumference length of the critical pattern portion, distance from the pattern profile, a gap from an adjacent pattern, and a pattern depth.

As described above, with the pattern verification method according to the embodiment, it is possible to verify the template target pattern on the basis of a feature value which causes the template target pattern to be determined as a critical pattern. That is, when forming a pattern on a device substrate using the imprint method, whether the template target pattern is good or not can be easily and promptly verified by comparing the feature values of the template target pattern and the feature values of a critical pattern.

Feature values of the critical pattern are calculated by considering variations of the patterns on the substrate in processes for forming the pattern on the device substrate on the basis of the imprint method. Therefore, a desired pattern can be formed on the device substrate by manufacturing the device on the basis of a pattern verified by the pattern verification method according to the embodiment.

Further, the pattern verification method according to the embodiment can reduce designer's correction workload more than the method according to the first embodiment does since only the template target pattern is corrected without correcting the design pattern. However, when it is determined in the verification step shown in (S4) of FIG. 7 that a critical pattern is contained in the verification pattern, the design pattern or the resist target pattern also may be corrected so as to produce a further precise template target pattern. When correcting the design pattern, a resist target pattern and a template target pattern are produced again after correction of the design pattern, and steps (S1) through (S5) shown in FIG. 9 are repeated until determined that a critical pattern is not contained in the verification pattern. When correcting the resist target pattern, a template target pattern is produced again after correction of the resist target pattern, and steps (S2) through (S5) shown in FIG. 9 are repeated until determined that a critical pattern is not contained in the verification pattern.

### Fourth Embodiment

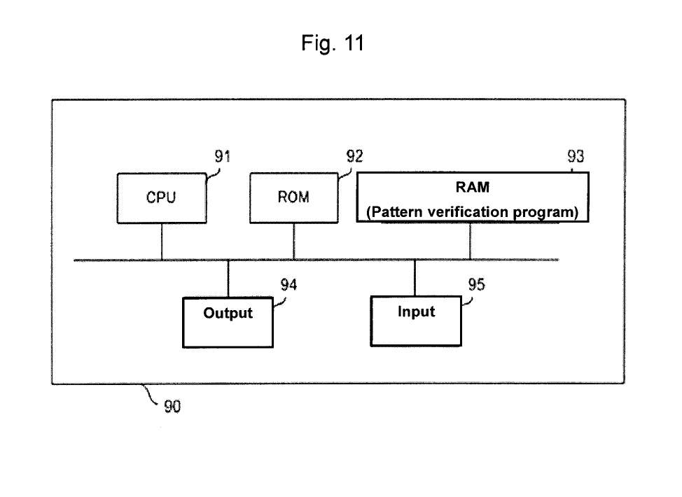

A pattern verification system used in performing the pattern verification methods according to the first embodiment to the third embodiment are described with reference to FIG. 11. FIG. 11 is a hardware configuration diagram showing a configuration of the pattern verification system used in performing the pattern verification method according to the first embodiment to the third embodiment.

A pattern verification system 90 comprises a CPU (Central Processing Unit) 91, a ROM (Read Only Memory) 92, a RAM (Random Access memory) 93, an output 94, and an input 95. In the pattern verification system 90, the CPU 91, ROM 92, RAM 93, output 94, and input 95 are connected with each other via a bus line.

The CPU 91 verifies, by using a pattern verification program of the computer program, whether the verification pattern is a critical pattern or not. Pattern verification is performed with reference to the feature values of the critical pattern.

The input 95 comprises a mouse and a keyboard and receives the verification pattern and the like. Information inputted into the input 95 is sent to the CPU 91. Feature values of the critical pattern are stored in the pattern verification system as the ROM 92 or stored in the RAM 93.

The pattern verification program is stored in the ROM 92 and loaded to the RAM 93 via a bus line. FIG. 11 shows a state where the pattern verification program has been loaded to the RAM 93. Before being stored in the pattern verification system 90, the pattern verification program is stored in a storage medium (CD-ROM or the like) outside the device.

The CPU 91 runs the pattern verification program loaded into the RAM 93. More specifically, in the pattern verification system 90, the CPU 91 reads the pattern verification program from the ROM 92 and develops the program to a program storage area in the RAM 93 to run processes in accordance with instructions inputted by a user through the input portion 95. The CPU 91 temporarily stores various data produced in these processes into a data storage area formed in the RAM 93.

The output 94 outputs a pattern verified by the pattern verification program.

By using the pattern verification system 90 configured as described above, a pattern verification method according to the first embodiment or the third embodiment can be performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern verification method for a pattern forming method in which a template pattern of a template is transferred to a resist on a substrate to thus form a resist pattern, and the substrate is processed by using the resist pattern as a mask to thus form a processed pattern, the pattern verification method comprising;
extracting any one of a design pattern of the processed pattern, a target pattern of the resist pattern, and a target pattern of the template pattern, as a verification pattern; and
verifying whether the verification pattern is a critical pattern or not by comparing a feature value of the verification pattern with a feature value of a critical pattern.

2. The pattern verification method according to claim 1, wherein the feature value of the pattern includes at least any one of a pattern shape, dimensions, a density, a circumference length, a gap from an adjacent pattern, and a pattern depth.

3. The pattern verification method according to claim 2, wherein the verifying whether the verification pattern is a critical pattern or not comprises verifying whether the verification pattern is a critical pattern or not by comparing the feature value of the verification pattern with a function representing risk by using a plurality of feature values of the critical pattern out of a pattern shape, dimensions, a density, a circumference length, a gap from an adjacent pattern, and a pattern depth.

4. The pattern verification method according to claim 1 or claim 2, wherein the feature values of the critical pattern are acquired by:
preparing a sample pattern of the verification pattern;
determining, through an experiment or simulation, a substrate pattern which is to be obtained by performing an imprint method using a sample template produced on the basis of the sample pattern;
extracting a critical portion of the substrate pattern; and
determining a feature value of a portion of the sample pattern, the portion corresponding to the critical portion.

5. A pattern generating method for a pattern forming method in which a template pattern of a template is transferred to a resist on a substrate to thus form a resist pattern, and the substrate is processed by using the resist pattern as a mask to thus form a processed pattern, the pattern generating method comprising;
extracting any one of a design pattern of the processed pattern, a target pattern of the resist pattern, and a target pattern of the template pattern, as a verification pattern;
verifying whether the verification pattern is a critical pattern or not by comparing a feature value of the verification pattern with a feature value of a critical pattern; and
adopting the verification pattern if the verification pattern is determined not to be a critical pattern as a result of the verification, and correcting the verification pattern in such a manner that the verification pattern does not become a critical pattern and adopting the corrected verification pattern if the verification pattern is determined to be a critical pattern.

6. A device fabrication method for manufacturing a device on the basis of the verification pattern adopted in the pattern generating method according to claim 5.

7. A pattern verification program for a pattern forming method in which a template pattern is transferred to a resist on a substrate to thus form a resist pattern, and the substrate is processed by using the resist pattern as a mask to thus form a processed pattern, the pattern verification program causing a computer to execute a procedure comprising:
verifying whether a verification pattern is a critical pattern or not by comparing a feature value of the verification pattern with a feature value of the critical pattern, the feature value of the verification pattern including any one of a design pattern of the processed pattern, a target pattern of the resist pattern, and a target pattern of the template pattern.

8. A pattern verification system for a pattern forming method in which a template pattern is transferred to a resist on a substrate to thus form a resist pattern, and the substrate is processed by using the resist pattern as a mask to thus form a processed pattern, wherein
whether a verification pattern is a critical pattern or not is verified cy comparing a feature value of the verification pattern with a feature value of the critical pattern, the feature value of the verification pattern including any one of a design pattern of the processed pattern, a target pattern of the resist pattern, and a target pattern of the template pattern.
